(19) United States
(12) Patent Application Publication
(10) Pub. No.: US 2010/0133725 A1
(43) Pub. Date: Jun. 3, 2010

(54) Mold With Reinforced Hinge

(76) Inventor: Douglas M. McCaskey, Sylvania, OH (US)

Correspondence Address: OWENS CORNING, 2790 COLUMBUS ROAD, GRANVILLE, OH, 43023, US

(21) Appl. No.: 12/325,335

(22) Filed: Dec. 1, 2008

(51) Int. Cl. B28B 1/14; B29C 43/02

(52) U.S. Cl. 264/299; 425/346

(57) ABSTRACT

Flexible, reinforced polymeric molds for Corning simulated stone veneers is provided. The molds are formed of a single solitary unit containing a plurality of contoured wells. A flange forms an outer portion of the mold and provides a means for grasping the mold so that the mold can be folded and flipped for the extraction of the artificial stones. One or both hinge portions located transversely across the central portion of the mold may be reinforced with an embedded nylon mesh scrim. The scrim increases the tear and tensile strength of the hinge portion. Additionally, the incorporation of the nylon mesh scrim at the hinge portions increases the life of the mold and reduces the occurrence of scrap molds. The polymeric mold advantageously retains its shape after the mold has been removed from the simulated stones, which permits the mold to be used in subsequent stone-molding operations.

### TECHNICAL FIELD AND INDUSTRIAL APPLICABILITY OF THE INVENTION

The present invention relates generally to molds for forming artificial stone, and more particularly, to a flexible polymeric mold reinforced with a reinforcing scrim member positioned at one or more hinge portions of the mold for the production of simulated stone or brick.

### BACKGROUND OF THE INVENTION

Simulated stone products include stone veneers and stone architectural trim products. Stone veneers are used as a lightweight veneer facing on masonry, and on metal flamed or wood framed construction for architectural aesthetics. The products can be used for exterior applications, such as on building walls, or for interior applications, such as to create an artificial stone fireplace. Stone veneers can include simulated natural stones, including stones such as granite, limestone, coral, or river rock. Stone veneers can also include simulated new or used brick products. Stone architectural trim products include capstones, hearthstones, keystones, and trim stones. Simulated stone products are usually lower in cost than the natural stones that they replace.

Cultured Stone® products are simulated stone products manufactured by Owens Corning Masonry Products, LLC, an affiliate of Owens Corning. The Cultured Stone® product line includes hundreds of designs of precast stone veneers and architectural trim products that replicate an extensive array of textures, sizes, shapes, and colors of natural stone.

Simulated stone products are manufactured using molds taken from natural stones or bricks. The molds generally include a mold cavity that is filled with a castable material. After the castable material has been cured, a flexible layer is manually stretched or pulled to remove the stone products from the mold. The molds must also be repetitively flipped to remove all of the stone products. The flipping and pulling of the molds cause tearing and distortion of the molds, particularly at the mold hinges, resulting in an undue amount of scrap molds and a relatively short life span of the mold. The preparation of the molds is both labor and cost intensive. Accordingly, there exists a need in the art for a mold that can resist tearing and extend the life of the mold and reduce the need to continuously manufacture new molds.

### SUMMARY OF THE INVENTION

It is an object of the present invention to provide a mold for manufacturing simulated stone products having major face, a back face opposed to the front face, a bottom face, and a plurality of side faces. The mold is formed of a flexible layer containing a plurality of mold cavities which give the simulated stone a desired shape, particularly that of a natural stone. The mold cavities include a major wall configured for imprinting a texture and shape that simulates the appearance of natural stone on the major face of the simulated stone product, a back wall opposed to the major wall configured to form the back face of the simulated stone product, a plurality of side walls extending between the major wall and the back wall and configured to form the side faces of the simulated stone product, and a bottom wall configured to form the bottom face of the simulated stone product. In exemplary embodiments, the back wall, the side walls, and the bottom wall are configured for imprinting a texture and shape that simulates the appearance of natural stone on the back wall, the side walls, and the bottom wall of the simulated stone product. A top wall of the simulated stone product is a screeded, substantially flat surface conducive for application to a structural surface. A flange forms an outer peripheral portion of the mold and provides a means for grasping the mold so that the mold can be folded and flipped to remove the simulated stones. Hinge portions are located transversely across the central portion of the mold between the mold cavities and are reinforced by a scrim member, such as a nylon mesh or fiberglass scrim. The scrim member serves to increase the tear and tensile strengths of the hinge portion. The incorporation of the reinforcing scrim member at the hinges of the mold enhances the life of the mold and reduces the occurrence of scrap molds caused by tearing or otherwise destroying the mold at the hinge portions.

It is an also object of the present invention to provide a method of manufacturing a mold for creating simulated stones. The mold has a flexible layer that includes a plurality of mold cavities, a flange portion that forms a periphery of the flexible layer, and at least one hinge portion located between the mold cavities to permit folding of the mold between the mold cavities. Manufacturing the mold includes: providing a master mold formed in a shape defining the mold cavities and corresponding to natural stones, inserting at least one scrim member on the master mold at locations corresponding to the hinge portions, introducing a polymeric material into the master mold to cover the at least one scrim member and the natural stones, and curing the polymeric material to create a mold having mold cavities formed in a shape corresponding to the natural stones with the scrim members integrally incorporated into the hinge portions. The method may also include the step of setting the natural stones in a base with a portion of the natural stones protruding from the base before the introducing step so that the polymeric material is poured around the portion of the natural stones protruding from the base. In exemplary embodiments, the step of setting the natural stones includes orientating the natural stones in a substantially vertical orientation such that the natural stones protrude from a top surface of the master mold. The base may be formed by pouring a curable urethane resin around the natural stones so that the natural stones are fixed in the base formed of the urethane resin with a portion thereof protruding from the base.

It is an advantage of the present invention that the reinforced molds are formed from an inexpensive polymeric material.

It is another advantage of the present invention that the embedded scrim increases the life of the mold.

It is a further advantage of the present invention that the fiberglass scrim increases the tensile and tear strengths of the mold.

It is a feature of the present invention that the reinforced mold is flexible, which permits the mold to be easily and quickly removed from the formed simulated stone.

It is also a feature of the present invention one or more hinge portions can be reinforced with a fiberglass scrim.

It is another feature of this invention that the reinforced mold can be formed to create a variety of shapes for the artificial stone.

It is still another feature of this invention that the reinforced mold retains its shape after it has been removed from the artificial stones formed therein.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a top plan view of a four cavity well having two scrim-reinforced hinges according to at least one embodiment of the present invention;

FIG. 2 is a is a top plan view of a four cavity well having a single scrim-reinforced hinge according to another embodiment of the present invention;

FIG. 3 is a side view of the mold illustrated in FIG. 1;

FIG. 4 is a perspective view of the top portion of a mold according to the present invention, the depth of the mold being shown in phantom;

FIG. 5 is a partial side view, in cross-section, of a mold apparatus;

FIG. 6 is a side view of the mold illustrated in FIG. 1 being folded about a reinforced scrim hinge according to at least one embodiment of the present invention; and

FIG. 7 is a side view depicting the removal of simulated stone from a reinforced mold according to at least one embodiment of the present invention.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references.

In the drawings, the thickness of the lines, layers, and regions may be exaggerated for clarity. It is to be noted that like numbers found throughout the figures denote like elements. It will be understood that when an element is referred to as being “on,” another element, it can be directly on or against the other element or intervening elements may be present. The terms “artificial stone” and “simulated stone” may be used interchangeably herein.

The present invention relates to flexible polymeric molds for forming artificial stone or simulated stone veneers. The molds are formed of a single unit containing a plurality of contoured wells defining mold cavities that are filled with a suitable mix of concrete, fillers, and/or pigments to form the simulated stone. The molds are reinforced with a reinforcing mesh scrim at one or more hinge portions of the mold. The scrim, which may be integrally formed in the mold at the hinge portions, serves to increase the tear and tensile strengths of the hinge portion. Additionally, the incorporation of a reinforcing mesh scrim at the hinges of the mold enhances the life of the mold and reduces the occurrence of scrap molds caused by tearing or otherwise destroying the mold at the hinge portions.

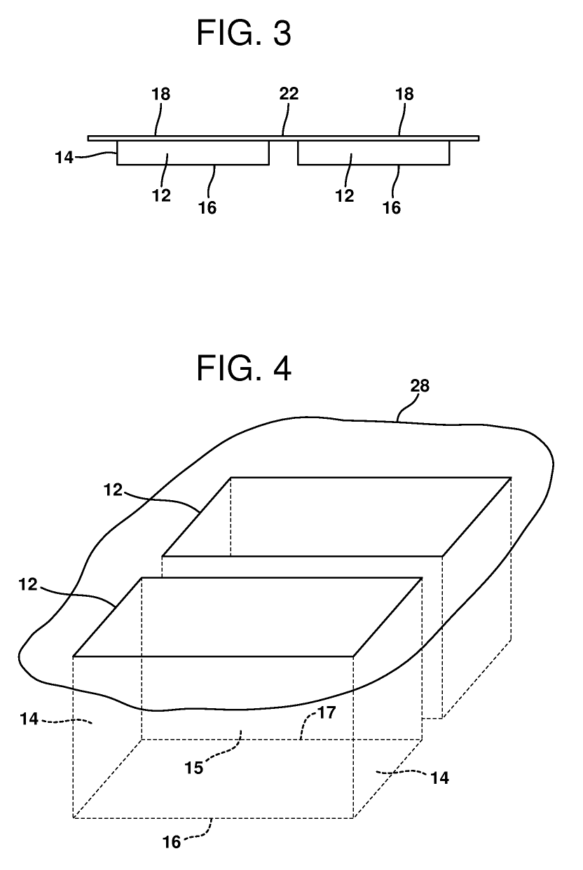

Referring to FIGS. 1-4, the reinforced polymeric mold can best be seen. The mold 10 includes a plurality of contoured wells or mold cavities 12 which give the simulated stone a desired shape, particularly that of a natural stone or brick. Each well 12 includes a major wall 15, a back wall 17, a bottom wall 16 and side walls 14. The side walls 14 extend between the major wall 15 and the back wall 17. In one embodiment, the major wall 15, the back wall 17, the bottom wall 16, and the side walls 14 are configured for imprinting a texture and shape that simulates the appearance of natural stone. A top wall of the simulated stone product is a screeded, substantially flat surface conducive for application to a structural surface. In a separate embodiment the major wall 15 is configured for imprinting a texture and shape that simulates the appearance of natural stone on the finished product, and the remaining walls 14, 16, and 17 of the mold cavity 12 are configured to form non-stone faces on the finished product. The mold 10 is a single, integrated structure,

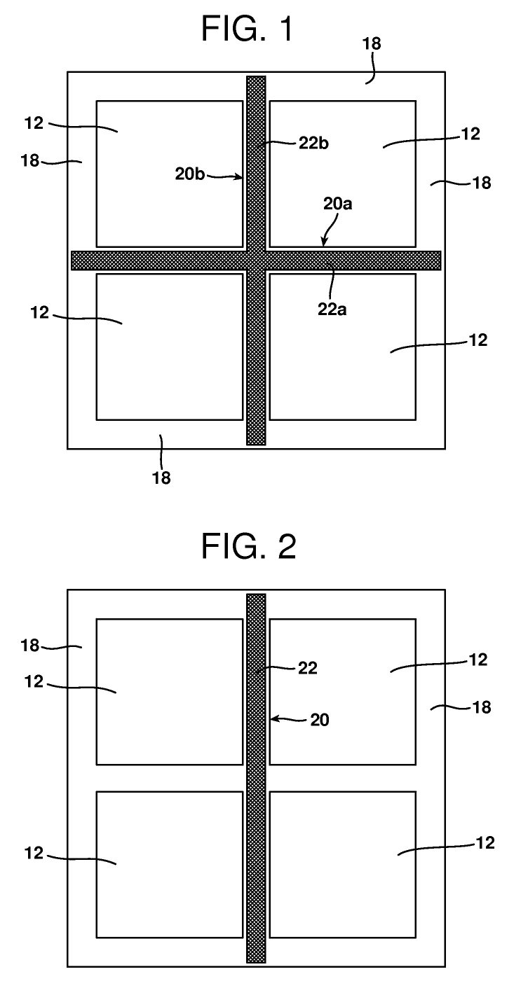

The mold 10 is formed of at least one flexible polymeric material (e.g., polyurethane), latex, or silicone rubber. The mold cavities 12 and have a depth and width sufficient to form a simulated stone with a desired size. A flange 18 forms an outer peripheral portion of the mold 10 and provides a means for grasping the mold 10 so that the mold 10 can be folded and flipped for the extraction of the simulated stones therefrom or carried by a carrying device or tray (not illustrated). In some instances, the flange 18 is more rigid than the inner portions of the mold to permit the folding of the mold. Hinge portions 20a, 20b are located transversely across the central portion of the mold 10 between the mold cavities 12. One or both of the hinge portions 20a, 20b may be reinforced with a scrim member 22. FIG. 1 illustrates an embodiment in which the hinge portions 20a, 20b in both the vertical and horizontal directions are reinforced by scrims 22a, 22b. However, it is to be appreciated that only one hinge portion may be reinforced by a scrim 22, such as is depicted in FIG. 2. The reinforced hinge portions 22a, 22b generally have a flexural modulus that is stiffer or more rigid than the flexural modulus of the remaining portions of the mold 10 due to the inclusion of the reinforcing scrim 22.

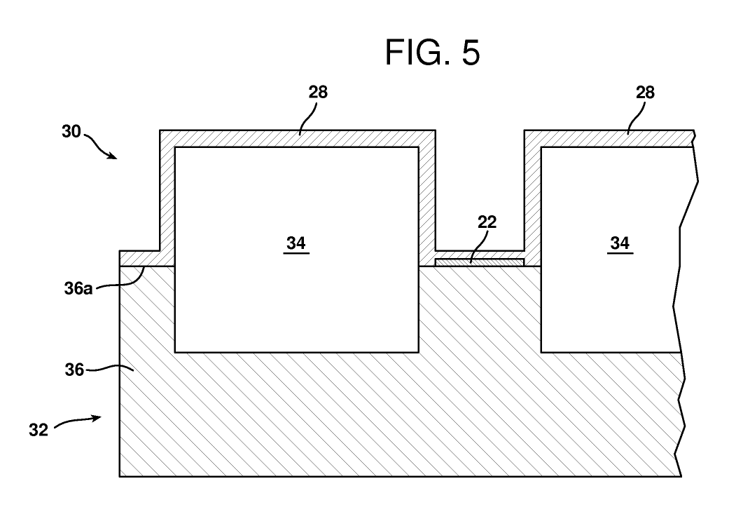

Simulated stone products are manufactured using molds taken from natural stones. A procedure for making the inventive reinforced molds is depicted in FIG. 5. As shown in FIG. 5, the molds are produced by a mold apparatus 30. The mold apparatus 30 includes a master mold 32 which is produced by setting natural stones 34 in a base 36. It is to be appreciated that FIG. 5 illustrates flat-shaped natural stones 34 for ease of illustration, and that any shape natural stone may be utilized in forming the mold 10. The stones 34 are chosen based on the size and shape of the stone, the lack of defects, and the presence of aesthetically pleasing material surface features on a major face of the stone 34. The natural stones 34 are arranged on the base 36 so that the major stone faces are oriented in a substantially vertical orientation and the stones 34 protrude from top surface 36a of the base 36 of the master mold 32. In FIG. 5, the stones 34 are positioned in a parallel arrangement, although it is within the purview of the invention to arrange the stones 34 in a non-parallel or other arrangement.

For the embodiment depicted in FIG. 1, namely, a mold 10 containing four mold cavities 12, four stones 34 are placed into the base 36 in a rectangular configuration as depicted in FIG. 1 The master mold 32 is made by pouring a curable urethane resin or similar curable base 36 around the stones 34 and allowing the urethane to cure around the natural stones 34 in the base 36.

After the base 36 has set and the stones 34 are substantially fixed into the base 36, a scrim member 22 is positioned transversely across the base 36 in at least one of the horizontal and vertical directions. At least one layer of a flexible polymeric material is then poured over and around the stones 34 and over the scrim member 22 lying on top of the base 36, thereby embedding the scrim 22 into the polymeric material 38 (and the mold 10). The polymeric material 38 conforms to the shape of the stones 34 and the exposed surface 36a of the base 36 and retains that shape when the flexible polymeric material 38 is removed from the master mold 32 and the stones 34 and is in use. When the flexible polymeric material 38 is cured, the mold 10 is removed from the master mold 32 (i.e., the base 36 and stones 34), thus freeing the mold 10 for use in manufacturing artificial stones.

In exemplary embodiments, the reinforcing scrim 22 is a nylon mesh scrim. However, it is within the purview of the invention that the reinforcing scrim may be formed of other materials, such as a fiberglass scrim, polyester, burlap, nylon mesh, and cotton blends. The scrim 22 may be embedded in the polymeric mold 10 or, alternatively, it may be positioned external to the mold 10. In such an embodiment, the scrim member 22 is fastened to the hinge portions 20a, 20b by an adhesive or tape. However, in most embodiments, the scrim 22 is embedded within the mold 10.

In operation, the wells 12 are filled with a castable material, such as a suitable mix of concrete, fillers, and/or pigments. The concrete mix is screeded flush with the top of the wells 12, such as by with a trowel, to remove excess material and provide a flat or substantially flat back surface so that the artificial stone may be adhered to a wall of a residential dwelling or building. Screeding ensures that the concrete mix does not protrude above the mold 10. The mold 10 depicted in FIG. 1 is a four cavity mold, and may form four separate simulated stones having a desired shape, texture, and pigmentation. It is to be appreciated that larger or smaller molds 10 may be formed containing larger or smaller numbers of mold cavities 12. It is also to be appreciated that the hinge portions are located in the mold 10 at locations that permit the mold 10 to be folded about the hinge portion to remove the simulated stone. Typically, a four cavity mold such as is depicted in FIG. 1 is approximately four feet by four feet in size and can form 19×20 inch artificial stones.

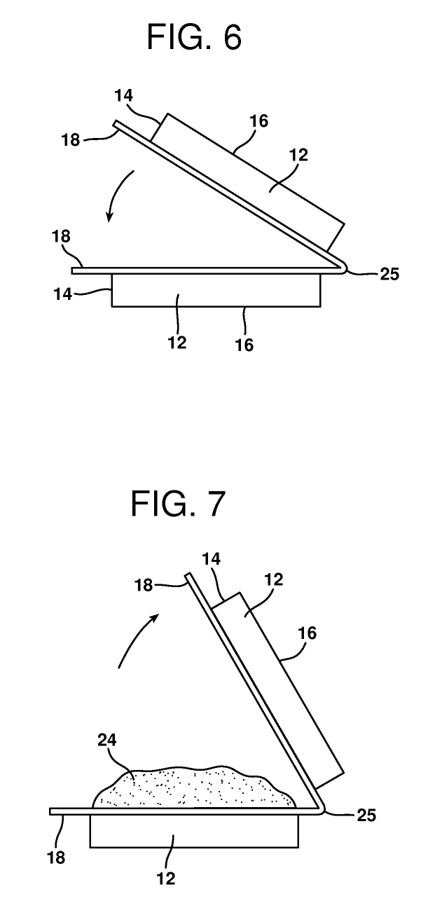

Once the wells 12 are filled with the concrete mixture, the concrete mixture is permitted to harden and set. The setting time for the concrete mixture is typically approximately 18-20 hours. The mold 10 is then folded about one of the scrim reinforced hinge 25 as shown in FIG. 6. After the mold 10 is completely folded, the mold 10 is removed from the simulated stones 24 in the first half of the mold 10 by peeling the mold 10 away from the simulated stones 24 as depicted in FIG. 7. The stones 24 from the wells 12 located in the first half of the mold 10 are then transported to a storage or packing area. To remove the stones remaining in the wells 12 located in the second half of the mold 10, the mold 10 is re-folded about the reinforced hinge portion, the mold 10 is flipped over 180 degrees, and the mold 10 is removed from the remaining stones.

Due to the flexible nature of the polymer material forming the mold 10, the mold may be easily and quickly removed from the artificial stones. Additionally, the scrim member 22 positioned on the hinge portion 20 provides increased tensile and tear strength to the hinge portion 20. As a result there is a reduced occurrence of scrap molds resulting from tearing the mold 10 as the mold 10 is folded about the hinge portion 20 or flipped to remove the additional stones. Additionally, the mold 10 advantageously retains its shape after the mold 10 has been removed from the simulated stones. This retention in shape permits the mold 10 to be used in subsequent stone-molding operations.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A mold for manufacturing stone products comprising:
a flexible layer having a plurality of mold cavities;
an outer flange forming a periphery of said flexible layer;
at least one hinge portion located transversely across a central portion of said mold between said mold cavities; and
at least one scrim member integrally formed into one or more hinge portions to reinforce said at least one hinge portion.

2. The mold of claim 1, wherein said mold cavities comprise:
a major wall configured for imprinting a texture and shape that simulates the appearance of natural stone on a major face of said stone product;
a back wall opposed to said major wall configured to form a back face of said stone product;
a plurality of side walls extending between said major wall and said back wall, said plurality of side walls being configured to form corresponding faces of said stone product; and
a bottom wall configured to form a bottom face of said stone product.

3. The mold of claim 2, wherein said back wall, said side walls, and said bottom wall are configured for imprinting a texture and shape that simulates the appearance of natural stone on said back wall, said side walls, and said bottom wall of said stone product.

4. The mold of claim 1, wherein said scrim member is adhered to said hinge portion.

5. The mold of claim 1, wherein said scrim member is embedded within said hinge portion.

6. The mold of claim 1, wherein said at least one scrim member is constructed from a material selected from the group consisting of fiberglass scrim, polyester, burlap, nylon mesh and cotton blends.

7. The mold of claim 1, wherein said at least one hinge portion includes a pair of hinge portions oriented in orthogonally extending directions intersecting between said mold cavities.

8. The mold of claim 7, wherein both said hinge portions are reinforced by corresponding said scrim members.

9. The mold of claim 73 wherein one of said orthogonally extending said hinge portions is reinforced by said scrim member.

10. The mold of claim 1T wherein said mold is a single integrated structure.

11. In a mold for manufacturing simulated stone products, said mold having a flexible layer defining a plurality of mold cavities, a flange portion forming a periphery of said flexible layer; and at least one hinge portion located between said mold cavities to permit folding of said mold between said mold cavities, the improvement comprising:
at least one scrim member integrally formed into said at least one hinge portion to reinforce said at least one hinge portion.

12. The mold of claim 1, wherein said at least one hinge portion includes a pair of hinges oriented in orthogonally extending directions intersecting between said mold cavities.

13. The mold of claim 12, wherein both said hinge portions are reinforced by corresponding said scrim members.

14. The mold of claim 12, wherein one of said orthogonally extending said hinge portions is reinforced by said scrim member.

15. The mold of claim 12, wherein said at least one scrim member is constructed from a material selected from the group consisting of fiberglass scrim, polyester, burlap, nylon mesh and cotton blends.

16. A method of manufacturing a mold for creating simulated stones, said mold having a flexible layer including a plurality of mold cavities, a flange portion forming a periphery of said flexible layer, and at least one hinge portion located between said mold cavities to permit folding of said mold between said mold cavities, comprising:
providing a master mold formed in a shape defining said mold cavities and corresponding to natural stones;
inserting at least one scrim member on said master mold at locations corresponding to said hinge portions;
introducing a polymeric material into said master mold to cover said at least one scrim member and said natural stones; and
curing said polymeric material to create a mold having mold cavities formed in a shape corresponding to said natural stones with said scrim members being integrally incorporated into said hinge portions.

17. The method of claim 16, wherein said providing step comprises:
setting said natural stones in a base with a portion of said natural stones protruding from said base before said introducing step so that said polymeric material is poured around said portion of said natural stones protruding from said base.

18. The method of claim 17, wherein step of setting said natural stones comprises orientating said natural stones in a substantially vertical orientation such that said natural stones protrude from a top surface of said master mold.

19. The method of claim 17, wherein said base is formed by pouring a curable urethane resin around said natural stones so that said natural stones are fixed in said base formed of said urethane resin with said portion thereof protruding from said base.

20. The method of claim 19, wherein said scrim member is constructed from a material selected from the group consisting of fiberglass scrim, polyester, burlap, nylon mesh and cotton blends.
